(19) United States
(12) Patent Application Publication
(10) Pub. No.: US 2012/0210298 A1
(43) Pub. Date: Aug. 16, 2012

(54) LOCATING CHANGES IN SOURCE CODE

(75) Inventors: Christopher Lindsay Hodgins, Hampshire (GB); Daniel Lisle, Bournemouth (GB)

(73) Assignee: INTERNATIONAL BUSINESS MACHINES CORPORATION, Armonk, NY (US)

(21) Appl. No.: 13/369,405

(22) Filed: Feb. 9, 2012

(30) Foreign Application Priority Data
Feb. 10, 2011 (EP) 11153990.4

(51) Int. Cl. G06F 9/44

(52) U.S. Cl. 717/113; 717/120; 717/122

(57) ABSTRACT

Tools are provided for locating changes in source code. More particularly, tools are provided for use with an integrated development environment having a source code management system for locating related changes in source code. Changed elements of target source code are located in a source code repository by acquiring a search term and by locating one or more references to changed elements of target source code containing the search term, wherein the located references are provided in order of the most recently changed located source code reference.

### CROSS-REFERENCE TO RELATED APPLICATIONS

This application claims priority to European Patent Application No. 11153990.4, filed Feb. 10, 2011, the disclosure of which is incorporated herein by reference.

### BACKGROUND

Various aspects of the present invention relate generally to locating changes in source code. In particular, aspects herein relate to an integrated development environment having a source code management system for locating related changes in source code.

In a source code management system, it is difficult to track what changes have been made or are going to be made to a specific value of code, thus making problem determination tricky. In a typical source code management system, each change of source code is recorded, sometimes as individually addressable database records or in a batch of change records saved in a file. But a lack of tracking functionality in source code management systems means that it is not easy to see what groups of changes could be responsible for a specific problem.

A change set is a group of changes grouped by a period of time, such as a day or a short period when the code has been checked in and out of a source code management system. A change set can comprise changes from a single developer or group of developers.

In many integrated development environments (IDEs) it is possible to manually search for occurrences of a string within a particular version of the source code with a view to editing the occurrence. However, with a manual search, all occurrences of the source code string that have been identified will be listed and there is no way of knowing which occurrences have more relevance to particular issue of concern to the user. Many IDEs that support a manual search do not offer a mechanism for performing further processing of the occurrences to identify more relevant occurrences of the source code string.

Moreover, some build tools provide the ability to index source code. However, such indexing does not allow searching within changes, and in particular, such indexing does not allow searching within those changes that are more likely to be related to a particular issue of concern to a user. As another example, NetBeans IDE adds process logic to a manual search ability. In response to a developer selecting an identifier in the source code, NetBeans IDE highlights usages of that identifier in the current source code. However, NetBeans IDE has many of the limitations set out above. NetBeans is a trademark of Oracle Corporation in the US and/or other countries.

### BRIEF SUMMARY

According to aspects of the present invention, changed elements of target source code are located in a source code repository by acquiring a search term and locating one or more references to changed elements of target source code containing the search term, wherein the located references are provided in order of the most recently changed located source code reference.

### BRIEF DESCRIPTION OF THE SEVERAL VIEWS OF THE DRAWINGS

Embodiments of the invention will now be described, by means of example only, with reference to the accompanying drawings in which:

FIG. 1 is a schematic deployment diagram of a prior art platform with an integrated development environment;

FIG. 2 is a schematic data diagram of source code in a source code repository according to an aspect of the present invention;

FIG. 3 is a schematic deployment diagram of an integrated development environment according to an aspect of the present invention;

FIG. 4 is a schematic process diagram of a method of a change set engine according to an aspect of the present invention;

FIG. 5 is a schematic process diagram of a method of a change set tool according to an aspect of the present invention;

FIG. 6 is an example of two different versions of source code files with the respective file delta and change records;

FIG. 7 is a diagram of a command prompt interface showing the output after a search operation of the example source code;

FIG. 8 is another diagram of the command prompt interface showing the output after a different search operation on the example source code; and

FIG. 9 is a diagram of a graphical user interface tool and associated code editor of an integrated development environment showing a screenshot output after a search operation on the example source code.

### DETAILED DESCRIPTION

Aspects of the present invention provide a method for locating changed elements of target source code in a source code repository comprising acquiring a search term, and locating one or more references to changed elements of target source code containing the search term, wherein the located references are provided in order of the most recently changed located source code reference.

As used herein, the term ‘version’ is used to identify particular target source code files in time. However, other terms could equally have been used such as ‘release’, ‘modification’ or ‘iteration’.

Also as used herein, the term ‘search term’ is used for a string of characters that identify a particular item of code that could be a variable; a constant; a program operation or any part of identifiable code. Where a single search term may be used, it is also envisaged that multiple search terms be usefully located in change files.

Still further as used herein, the term ‘code identifier’ is used to identify the source code target. For example, the code identifier for the source code target program 140 and 140′ (described in greater detail herein) could be ‘Program’ or ‘X’ or any other identifier.

In the present description, the term ‘creation time’ is used when describing both the creation date and time of a code or delta file. The term ‘file delta’ is used to refer to a file that contains one or more code changes between a new and an old version of a source code file. In an alternative arrangement, each code change between a new and an old version of a source code file is represented by an individual record in a database.

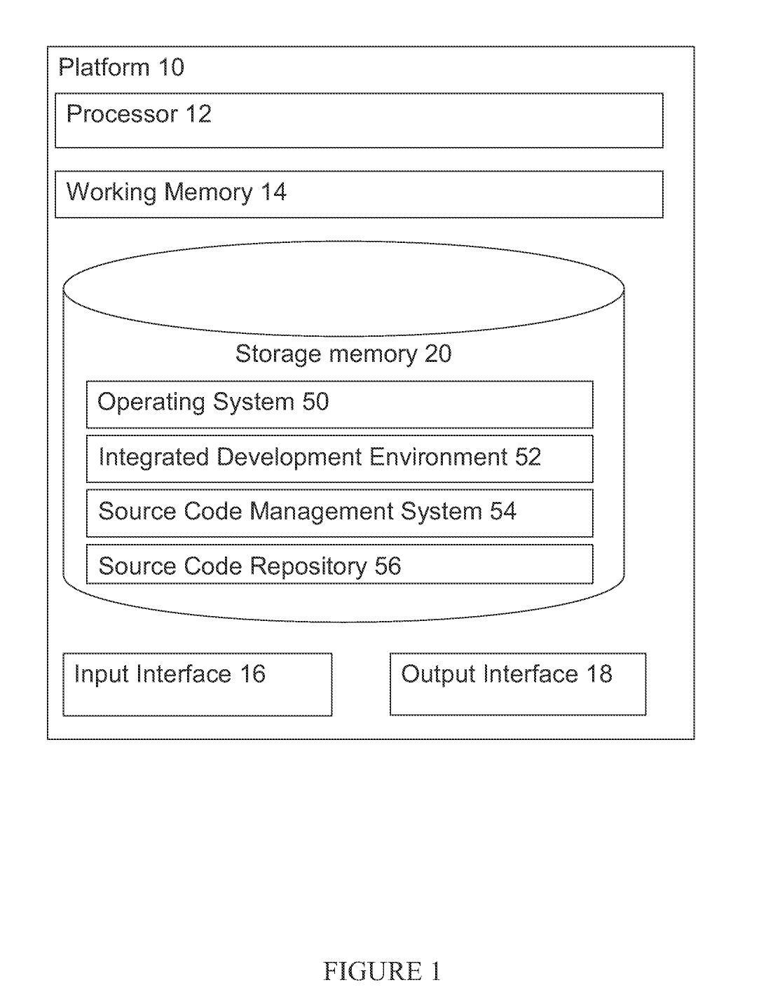

Referring to FIG. 1, there is shown a deployment diagram of an operational platform 10 for interaction with user. The platform 10 comprises a processor 12, working memory 14, an input interface 16, an output interface 18 and storage memory 20. An example of platform 10 is an International Business Machines (IBM) POWER 750 Express server.

The processor 12 takes instructions and data from the working memory 14 for performing logical operations on data according to the instructions. Examples of instructions include: add data, subtract data, read data, write data, etc. An example of a processor is an IBM POWER7 processor. IBM, Express, POWER and POWER7 are trademarks of International Business Machines in the US and/or other countries.

The working memory 14, which is typically faster than the storage memory 20, is designed for fast access so that it does not limit processor speed. In operation, the processor 12 accesses and executes code stored in the working memory 14. An example of the code is operating system code and application code. An example of execution memory is 8 GB to 512 GB registered dual in-line memory modules (RDIMM) comprising a series of dynamic random access memory (DRAM) integrated circuits.

The input device 16 is for receiving input from the user via a keyboard, mouse or other human input device.

The output interface 18 is for sending output to the user via a screen, speakers or other human output device.

The storage memory 20 is typically slower than the working memory 14 but is designed to hold much more data than the working memory 14. An example of storage memory 20 is 8 Tb (terabyte) disk drive. When the platform is not operating, then working memory 14 is empty and storage memory 20 stores both execution code for upload to working memory 14 and data for use with the execution code. The execution code of an exemplary embodiment comprises an operating system 50, an integrated development environment 52 and a source code management system 54. The data can be stored, for instance, in a source code repository 56.

The operating system 50 is for providing basic platform operating functions such as file storage and input/output functions.

The integrated development environment (IDE) 52 provides the source code editing functions and interface.

The source code management system 54 manages the loading and saving of source code files to and from the source code repository 56. The source code management system 54 maintains: an existing source code file; a file delta containing changes to the existing source code; and a new source code file. Such a system is similar to a versioning or journaling operating system but is specific to source code management.

The source code repository 56 stores source code files and file deltas as maintained by the source code management system 54.

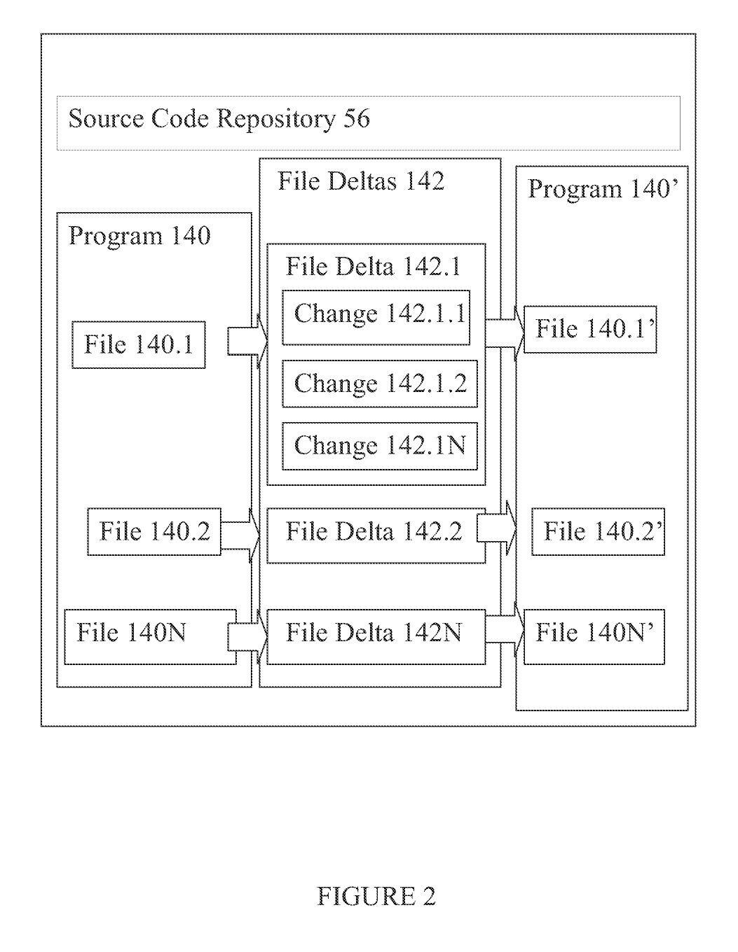

FIG. 2 shows example programs stored in source code repository 56 including: source code program 140 (for example program X version Y-1); file deltas 142 and source code program 140′ (for example program X version Y). Program 140 comprises at least three source code files 140.1, 140.2 and 140N. When changes are made to program 140 the change operations are save in file delta 142 and the changed program is saved as new program version 140′. The example changes comprise at least three changes to file 140.1 including change 142.1.1; change 142.1.2 and change 142.1N all saved in file delta 142.1. When file delta 142.1 is applied to file 140.1, file 140.1′ is rendered. A second file delta 142.2 is applied to file 140.2 to render file 140.2′. An nth file delta 142N is applied to file 140N to render 140N′. In the example, three file deltas 142.1, 142.2 and 142N comprise the change set that was applied to program 140 to render program 140′. A similar set of changes could exist for past versions (for example, Program X Version Y-2 and Y-N). Each time the letter n or N is used in this description it could mean any number and does not mean a specific number.

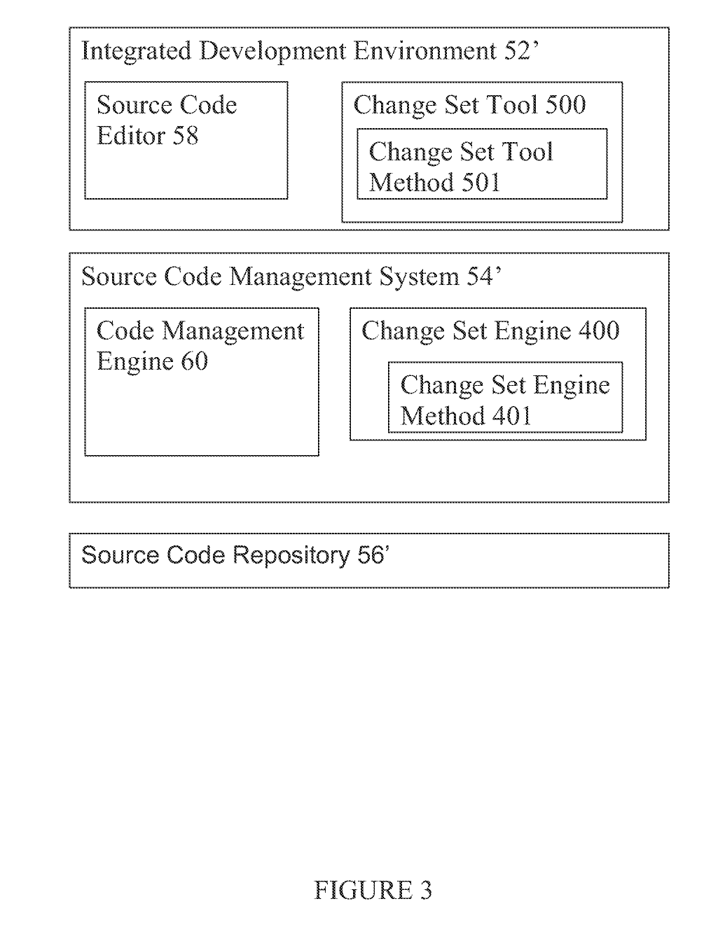

Referring to FIG. 3 there is shown an integrated development environment (IDE) 52′; a source code management system 54′ and a source code repository 56′ according to aspects of the present invention. The IDE 52′, source code management system 54′ and a source code repository 56′ can comprise for instance, like components illustrated in FIG. 1, i.e., the IDE 52, source code management system 54 and a source code repository 56.

The IDE 52′ comprises: a source code editor 58 and a change set tool 500.

The source code management system 54′ comprises a code management engine 60 and change set engine 400.

The source code management system 56′ is similar to a conventional source code management system 56.

The source code editor 58 is for creating and saving a source code file, or loading, editing and saving a source code file.

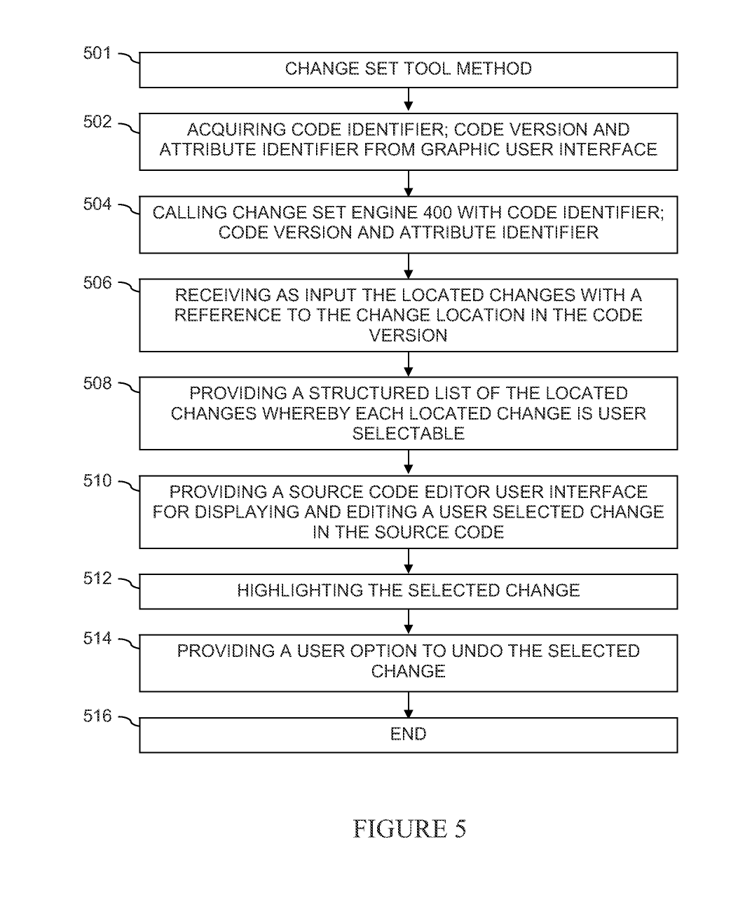

The change set tool 500 comprises a change set tool method 501, which is the primary user interface logic according to aspects of the present invention. The change set tool method 501 is described in more detail below with reference to FIG. 5.

The code management engine 60 is for saving changes performed by the IDE 52′ as discrete instructions in file delta 142 for operation on a older version of program source code 140 and also as a complete new version of the program source code 140′ after the operation has been performed on the older version.

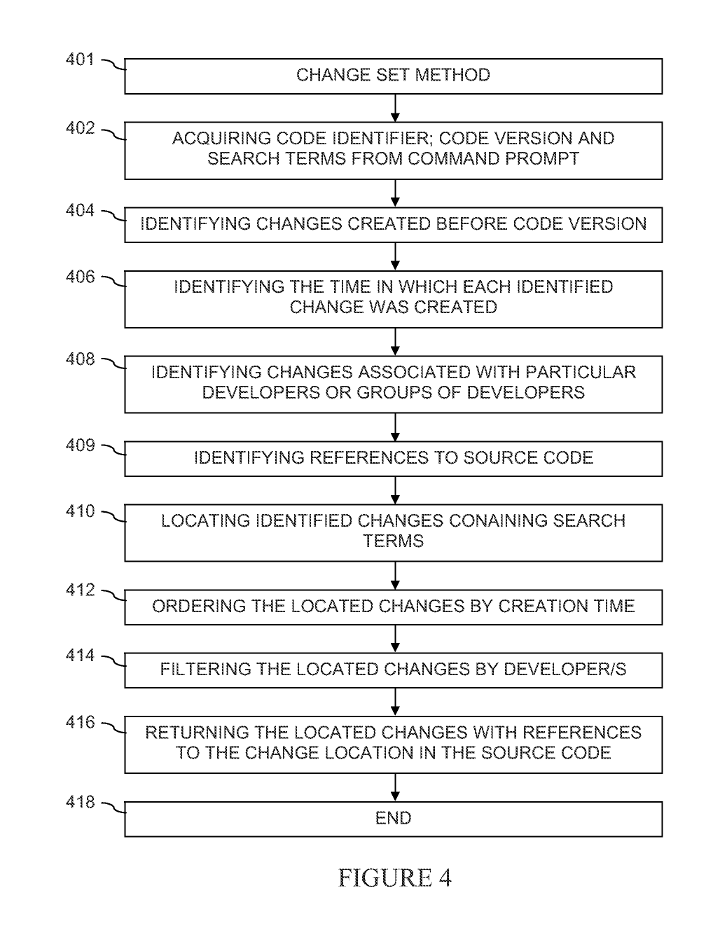

The change set engine 400 comprises a change set engine method 401, which is the primary logical method of the present embodiment. The change set engine method 401 is described in more detail below with reference to FIG. 4.

Referring to FIG. 4, there is described a change set engine method 401, comprising logical process steps 402 to 418.

The method comprises acquiring, at 402, a program code identifier; a program code version and search terms from a user interface, such as a command prompt or directly from an invoking mechanism such as change set tool method 501 (discussed in greater detail below).

The method also comprises identifying, at 404, changes created before the code version. The creation time of the code version is identified. The source code repository 56′ is searched to locate all changes that have a creation time before that of the code version.

The method further comprises identifying, at 406, the time in which each identified change was created by extracting the time with the located changes from the source code repository 56′.

The method still further comprises identifying, at 408, changes associated with particular developers or groups of developers by extracting the developer identifications with the located changes from the source code repository 56′, and identifying, at 409, references to source code files by extracting the references with the located changes from the source code repository 56′.

The method also comprises locating at 410, identified changes that contain the search terms by performing a search over the extracted changes for the search terms, and ordering, at 412, the located changes by creation time.

The method yet further comprises filtering, at 414, the located changes by developer or group of developers.

In an illustrative embodiment, the operations at 404 to 414 are executed as a single source code repository query using a search query in a language such as Xpath or SQL.

The method still further comprises returning at 416, the located changes with a reference to the change location in the code version. The located changes and references are returned as a structured list. If the change set engine 400 is called from a command prompt window then the located changes are presented in the command prompt window as a structured list. If the change set engine is called from any other method then the located changes are returned as a structured list in a linear text string. The method ends at 418. The operations described with reference to FIG. 4 can be carried out, for instance, by the processor 12 of FIG. 1, by executing program code stored in the working memory 14 and/or storage memory 20.

Referring to FIG. 5, there is described change set tool method 501 comprising logical processes 502 to 516.

The method comprises acquiring at 502, a program code identifier; code version and attribute identifier from a graphic user interface, and calling, at 504, the change set engine 400 with code identifier; code version and attribute identifier.

The method also comprises receiving as input, at 506, the located changes with a reference to the change location in the code version, and providing, at 508, a structured list of the located changes whereby each located change is user selectable.

The method further comprises providing, at 510, a source code editor user interface for displaying and editing a user selected change in the source code, and highlighting, at 512, the selected change.

The method still further comprises providing, at 514, a user option for undoing the selected change. The change set tool method ends at 516. The operations described with reference to FIG. 5 can be carried out, for instance, by the processor 12 of FIG. 1, by executing program code stored in the working memory 14 and/or storage memory 20.

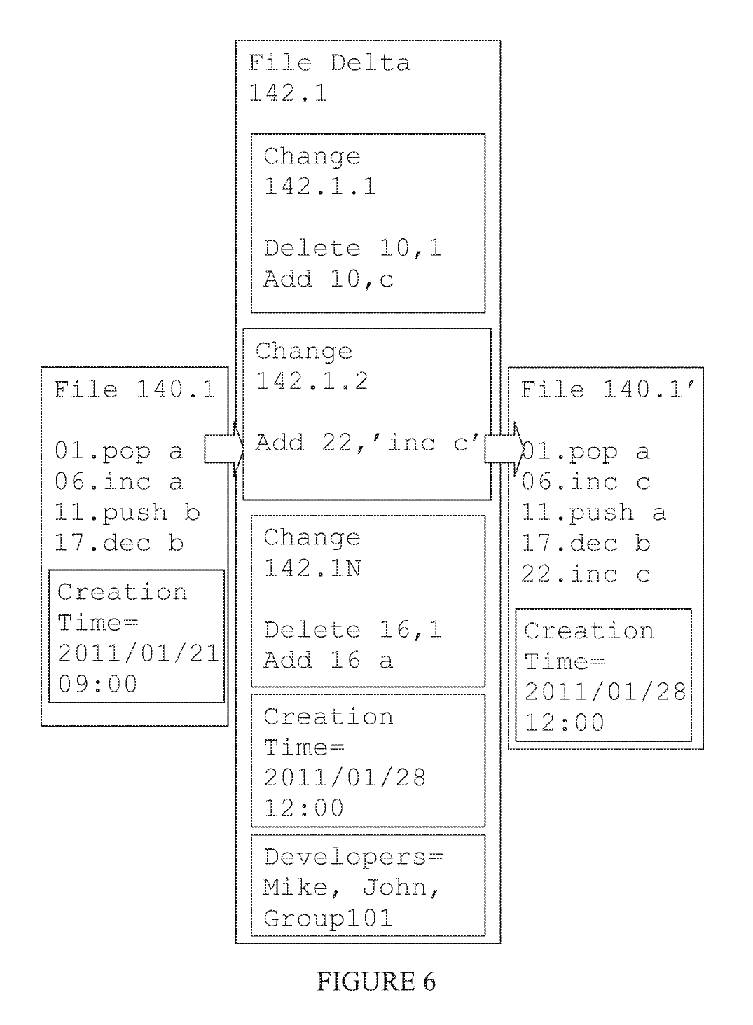

Examples of the operation of an illustrative embodiment are described below with reference to FIGS. 6 to 9.

FIG. 6 shows an example of a first version of source code file 140.1 and an example of the next version of the source code file 144.1 after changes have been made, which has been saved in file delta 142.1.

File 140.1 comprises a structure filed having four instructions (pop a; inc a; push b; and dec b) and metadata regarding the creation time of the file. The instructions are in plain text format and include added adjacent character positions: 01; 06; 11; and 17. In this example, the source code file comprises a linear string of characters and each character has a position relative to the start of the file. The example program is not a working program and serves only to illustrate how changes can be saved, applied and undone. The first instruction ‘pop a’ is for instructing the loading of register ‘a’ with a value from a stack. The second instruction ‘inc a’ is for instructing incrementing of register ‘a’. The third instruction ‘push b’ is for stacking register ‘b’ onto the stack. The fourth instruction ‘dec b’ is for instructing decrementing register ‘b’. Creation time indicates that file 140.1 was created on 21/01/2011 at 09:00 hours.

File 140.1′ shows the next version of the source code file 140.1′ after changes have been made. Creation time for file 140.1′ is 12:00 hours on 28/01/2011. The instructions have been changed: ‘inc a’ is now ‘inc c’; ‘push b’ is now ‘push a’; and ‘inc c’ has been appended to the file.

These changes are saved in file delta 142.1 as change 142.1.1; change 142.1.2; and change 142.1.N. File Delta 142.1 also comprises creation time data (Creation Time=2011/01/28 12:00) and developer data (Developers=Mike, John and Group101). Change 142.1.1 deletes a character at position 10 and inserts ‘c’ at position 10. Change 142.1.2 adds at position 22 ‘inc c’. Change 142.1N deletes a single character at position 16 and adds ‘a’ at position 16.

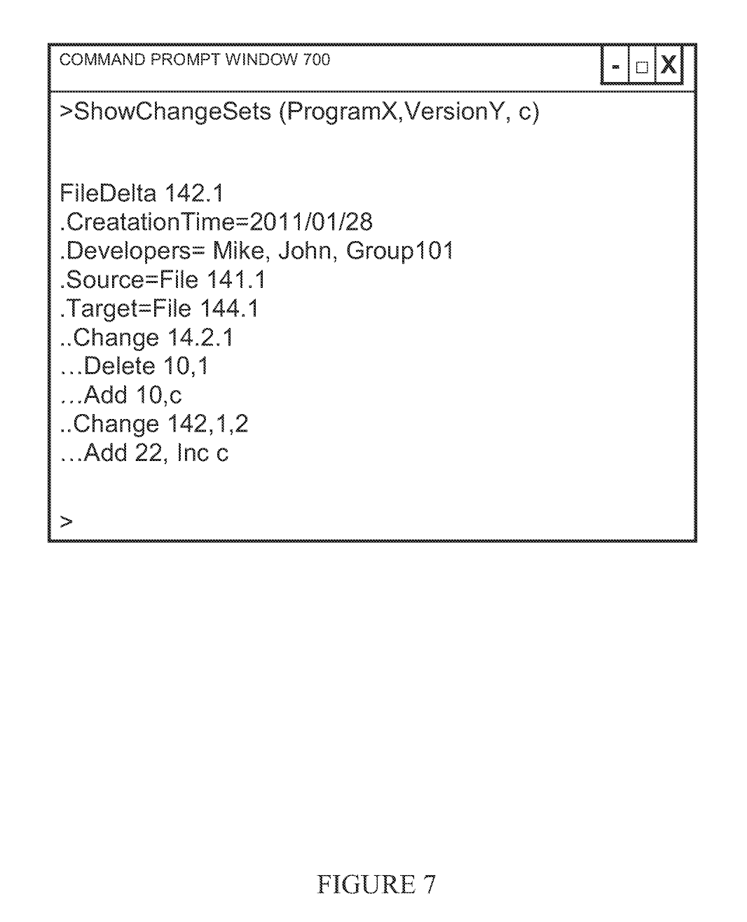

FIG. 7 is a diagram of a command prompt interface showing the output after a search operation on the example source code.

A user executes command line window 700 as provided by the operating system 50. At the prompt, user 11 types the command: >ShowChangeSets (ProgramX,VersionY, c)

In the above exemplary command, ‘ShowChangeSets’ is the command that executes the change set engine 400 and the terms in brackets are passed from the command line window to the change set engine 400. Change set engine acquires: parameter ‘ProgramX’, an example program identifier; parameter ‘VersionY’, an example program version; and parameter ‘c’; an example search term for the changes of interest.

The changes created on or before the creation of program X version Y and containing the search term ‘c’ are located. In this example, only one set of changes between two versions are described for simplicity but the benefits of the invention are realized for many change sets over several versions of the program source.

The change set engine extracts or implies information such as the creation time of each located change, the developer or developers making the changes and the references to source code, by the change set engine querying the source code repository 56′.

The change set tool 400 locates two changes, change 14.2.1 and change 14.2.2, that each contain the search term ‘c’.

The change set tool 400 orders located changes by creation time. For a single file delta the order of creation is the physical order in the file delta. For more than one file delta, the creation date of the file delta is also used.

Change set tool 400 provides the located changes to the command line window 700. The file delta is identified with the creation date. In this example, the developers making changes in the file delta are listed. Then, the changes and details of the changes are listed in order including the source and target files and the reference into the target file.

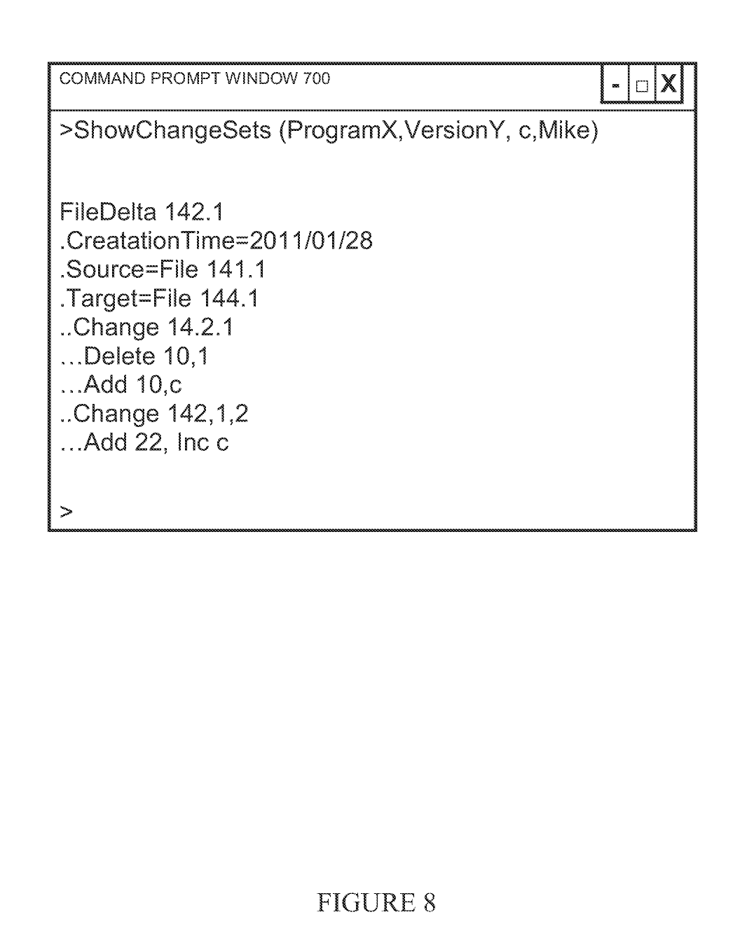

FIG. 8 is another diagram of the command prompt window 700 showing the output after a similar search operation on the same example source code but filtering the results by developer Mike.

The user executes command prompt window 700 and at the prompt the user types the command: >ShowChangeSets (ProgramX,VersionY, c, Mike)

The terms in brackets are passed from the command line window to the change set engine 400. In particular, the change set engine 400 further acquires: parameter ‘Mike’, an example developer identifier.

The change set engine 400 would then filter the located changes using the developer called Mike. Since this example is very simple the results are no different from the previous example; however, if additional file delta did not have Mike as a developer then they would not be included.

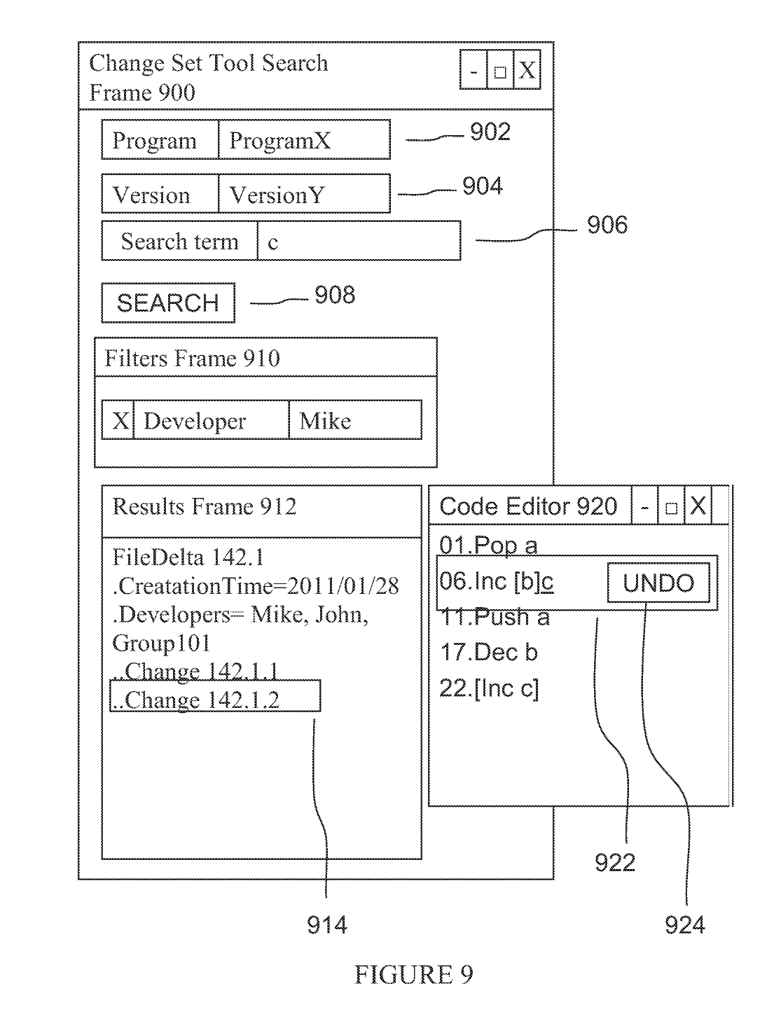

FIG. 9 is a diagram of an example change set tool search frame 900 and associated code editor 920 of an integrated development environment showing a screenshot output after a search operation on the example source code.

The change set tool search frame 900 is the graphical user interface for the change set tool 500. The change set tool search frame 900 comprises: a program input box 902; a version input box 904; a search term input box 906; a search button 908; a filter frame 908; and results frame 912.

The program input box 902 comprises an input field for user input of text, such as ‘ProgramX’ in this example.

The version input box 904 comprises an input field for user input of text, such as and ‘VersionY’ in this example.

The search term box 906 comprises an input field for user input of text for the search terms, such as ‘c’ in this example.

On selection and execution of search button 908, the change set tool 500 is executed and the parameters in the boxes 902, 904 and 906 are passed through.

Filters frame 910 displays possible filters after the search has been first completed and allows the user to select one or more filters. In this case the user has selected to use the developer filter for Mike, the developer. Once selected the change set tool is executed again with this new restriction.

The results frame 912 displays the results of the search, which are passed back from the change set tool 500. The output is similar to the command prompt window except for the detail and the ability for the user to select a change. In the example, change 142.1.1 and change 142.1.2 are listed in order and a highlight 914 is selecting change 142.1.1 (of file delta 142.1).

The code editor 920 synchronizes with the selection in the results frame 912 and displays the source code of target file 140.1′ of file delta 142.1 of selected change 142.1.1. The change set tool enables the resultant source code to be highlighted by box 922. The change set tool also enables the resultant source code to be marked up such that the user can see the details of the change in the context of the surrounding source code. The change 142.1.1 is shown as having deleted ‘b’ by showing ‘b’ between square brackets [b] and as having inserted ‘c’ by showing ‘c’ as underlined ‘c’. An undo button 924 is displayed and the user can select the edit be undone whereby the source code would revert to that before the change.

### Other Embodiments

As noted throughout the disclosure herein, and with reference to the FIGURES generally, aspects of the present invention provide a method for locating changed elements of target source code in a source code repository comprising acquiring a search term, and locating one or more references to changed elements of target source code containing the search term, wherein the located references are provided in order of the most recently changed located source code reference.

As an illustrative example, a source code search term is selected for analysis (for example a variable name or constant) and the method and system looks at change data stored as change sets (shown in FIG. 2 as file deltas) for the respective target source code. The system queries all change sets for the search term and if a change is located then its respective source code reference is included with the located change. If the change does not have an individual change creation time then the creation time of the change set is used. If a change does not have a developer or developers associated with its creation then the developer or developers of the change set is used for each of the contained changes.

According to further aspects herein, each change is stored individually along with creation time and developer metadata. As such, if execution of the target source code program produces errors, then recent changes to the source code directly or indirectly affecting the search term can be identified.

Aspects herein can be used when servicing existing code where little is known about the background of the code development. Moreover, aspects of the present invention are useful in tandem with cross-referencing tools.

According to aspects of the present invention, source code files that are being worked upon, and that are associated delta files, are persistently saved in a source code repository so that the search term can be located in finalized versions, and in progress versions, of the source code.

Aspects herein provide a user interface containing the list of located references, whereby each located reference item is user selectable for performance of an operation on a corresponding change in a corresponding source code file. As such, on user select of a located reference, a source code user interface is provided, containing the corresponding source code file with change highlighted in the context of the surrounding source code.

The source code user interface can comprise, for instance, an editor that allows the user to edit the change and the surrounding source code directly. In an illustrative implementation, on user selection of a located reference, the system and method provide a user option for undoing the selected change. For instance, the located references are filtered by a developer identification or group identification of developers that created the change.

Aspects can be implemented within an integrated development environment, a source code management system, a source code repository, etc.

Moreover, the selectable reference items can be provided as part of an integrated development environment where the reference items themselves are provided a source code management system, etc. As another illustrative example, all the functionality code can be provided directly in a source code repository, e.g., a versioning file system.

Program source code is not limiting. For instance, and in another embodiment any computer readable code, for instance markup language may be the changed code. In a different embodiment, the source code repository is a file system provided as software, firmware or hardware. The file system may alternatively be implemented as a type of versioning, revision, or journaling file system.

According to further aspects of the present invention, there is provided a system for locating changed elements of target source code in a source code repository comprising: acquiring a search term; and locating one or more references to changed elements of target source code containing the search term, wherein the located references are provided in order of the most recently changed located source code reference.

According to still further aspects of the present invention, there is provided a computer program product comprising computer readable recording medium having computer readable code stored thereon for locating changed elements of target source code in a source code repository, the computer readable code which when loaded onto a computer system and executed performs the following steps: acquiring a search term; and locating one or more references to changed elements of target source code containing the search term, wherein the located references are provided in order of the most recently changed located source code reference.

All or part of the method disclosed herein, may suitably and usefully be embodied in a logic apparatus, or a plurality of logic devices, comprising logic elements arranged to perform the steps of the method and that such logic elements may comprise hardware components, firmware components or a combination thereof.

All or part of a logic arrangement implementing aspects of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors and that the software may be provided in the form of one or more computer program elements carried on any suitable data-carrier such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible storage medium, such as a computer readable medium, or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the preferred embodiment of the present invention may be realized in the form of a computer implemented method of deploying a service comprising deploying computer program code operable to, when deployed into a computer infrastructure and executed thereon, cause the computer system to perform all the steps of the method.

In a further alternative, the preferred embodiment of the present invention may be realized in the form of a data carrier having functional data thereon, said functional data comprising functional computer data structures to, when loaded into a computer system and operated upon thereby, enable said computer system to perform all the steps of the method. It will be clear to one skilled in the art that many improvements and modifications can be made to the foregoing exemplary embodiment without departing from the scope of the present invention.

As such, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

What is claimed is:

1. A method for locating changed elements of target source code in a source code repository comprising:
acquiring a search term; and
locating one or more references to changed elements of target source code containing the search term, wherein the located references are provided in order of the most recently changed located source code reference.

2. The method according to claim 1 further comprising providing a user interface containing the list of located references whereby each located reference item is user selectable for performance of an operation on a corresponding change in a corresponding source code file.

3. The method according to claim 2 further comprising, providing a source code user interface upon user selection of a located reference, where the provided source code user interface contains the corresponding source code file with each change highlighted in the context of the surrounding source code.

4. The method according to claim 3, further comprising, providing the source code user interface as an editor that enables the user to edit the change and the source code directly.

5. The method according to claim 2 further comprising, providing a user option to undo the selected change upon a user selection of a located reference.

6. The method according to claim 1, further comprising filtering the located references by a developer identification or group identification of developers that created the change.

7. A system for locating changed elements of target source code in a source code repository comprising:
a processor and memory coupled to the processor, the memory programmed with code to cause the processor to locate changed elements of target source code, comprising:
acquiring a search term; and
locating one or more references to changed elements of target source code containing the search term, wherein the located references are provided in order of the most recently changed located source code reference.

8. The system according to claim 7 wherein the memory is further programmed such that when executed by the processor, the system provides a user interface containing the list of located references whereby each located reference item is user selectable for performance of an operation on a corresponding change in a corresponding source code file.

9. The system according to claim 8 wherein the memory is further programmed such that when executed by the processor, the system provides a source code user interface upon user selection of a located reference, the user interface containing the corresponding source code file with change highlighted in the context of the surrounding source code.

10. The system according to claim 9, wherein the source code user interface is implemented as an editor that enables the user to edit the change and the source code directly.

11. The system according to claim 7 wherein the processor and memory are implemented within an integrated development environment.

12. The system according to claim 7 wherein the processor and memory are implemented within a source code management system.

13. The system according to claim 7 wherein the processor and memory are implemented within a source code repository.

14. The system according to claim 13 wherein the source code repository is a versioning file system.

15. A computer readable storage medium having computer readable code stored thereon for locating changed elements of target source code in a source code repository, said computer readable code which when loaded onto a computer system and executed performs instructions comprising:
acquiring a search term; and
locating one or more references to changed elements of target source code containing the search term, wherein the located references are provided in order of the most recently changed located source code reference.

16. The computer program product according to claim 15 further comprising computer readable code for providing a user interface containing the list of located references whereby each located reference item is user selectable for performance of an operation on a corresponding change in a corresponding source code file.

17. The computer program product according to claim 16 further comprising computer readable code for providing a source code user interface, based upon a user selecting a located reference, wherein the source code user interface contains the corresponding source code file with change highlighted in the context of the surrounding source code.

18. The computer program product according to claim 17, wherein the computer readable code for providing a source code user interface comprises computer readable code for implementing an editor that enables the user to edit the change and the source code directly.

19. The computer program product according to claim 16 further comprising computer readable code for providing a user option to undo the selected change based upon user selection of a located reference.

20. The computer program product according to claim 15, further comprising computer readable code for filtering the located references by a developer identification or group identification of developers that created the change.
